(19) United States
(12) Patent Application Publication
(10) Pub. No.: US 2006/0251188 A1
(43) Pub. Date: Nov. 9, 2006

(54) Common-mode suppression circuit for emission reduction

(75) Inventors: Philip John Crawley, Folsom, CA (US); John R. Camagna, El Dorado Hills, CA (US); Amit Gattani, Roseville, CA (US)

Correspondence Address: KOESTNER BERTANI LLP, 18662 MACARTHUR BLVD, SUITE 400, IRVINE, CA, 92612, US

(73) Assignee: Akros Silicon, Inc.

(21) Appl. No.: 11/327,128

(22) Filed: Jan. 6, 2006

Related U.S. Application Data
(63) Continuation-in-part of application No. 11/207,595, filed on Aug. 19, 2005.
(63) Continuation-in-part of application No. 11/207,602, filed on Aug. 19, 2005.
(60) Provisional application No. 60/665,766, filed on Mar. 28, 2005.

(51) Int. Cl. H04L 25/06

(52) U.S. Cl. 375/319

(57) ABSTRACT

In a network device, an interface is coupled between an Ethernet physical layer (PHY) module and a network connector, and comprises at least one pair of pins coupled to output connections of the Ethernet physical layer (PHY), a direct current (DC) blocking capacitor coupled to each pin, and a common-mode suppression amplifier coupled between the paired pins.

### CROSS REFERENCE TO RELATED APPLICATIONS

This application claims the benefit of priority to and incorporates herein by reference in its entirety for all purposes, U.S. Provisional Patent Application No. 60/665,766 entitled “SYSTEMS AND METHODS OPERABLE TO ALLOW LOOP POWERING OF NETWORKED DEVICES,” by John R. Camagna, et al. filed on Mar. 28, 2005. This application is related to and incorporates herein by reference in its entirety for all purposes, U.S. patent application Ser. No.: 11/207,595 entitled “METHOD FOR HIGH VOLTAGE POWER FEED ON DIFFERENTIAL CABLE PAIRS,” by John R. Camagna, et al. filed Aug. 19, 2005; and Ser. No. 11/207,602 entitled “A METHOD FOR DYNAMIC INSERTION LOSS CONTROL FOR 10/100/1000 MHZ ETHERNET SIGNALLING,” by John R. Camagna, et al., which have been filed concurrently filed Aug. 19, 2005.

### BACKGROUND

Many networks such as local and wide area networks (LAN/WAN) structures are used to carry and distribute data communication signals between devices. Various network elements include hubs, switches, routers, and bridges, peripheral devices, such as, but not limited to, printers, data servers, desktop personal computers (PCs), portable PCs and personal data assistants (PDAs) equipped with network interface cards. Devices that connect to the network structure use power to enable operation. Power of the devices may be supplied by either an internal or an external power supply such as batteries or an AC power via a connection to an electrical outlet.

reduction in the number of power cables, AC to DC adapters, and/or AC power supplies which may create fire and physical hazards. Additionally, power distributed over a network such as an Ethernet network may function as an uninterruptible power supply (UPS) to components or devices that normally would be powered using a dedicated UPS.

Additionally, network appliances, for example voice-over-Internet-Protocol (VOIP) telephones and other devices, are increasingly deployed and consume power. When compared to traditional counterparts, network appliances use an additional power feed. One drawback of VOIP telephony is that in the event of a power failure the ability to contact emergency services via an independently powered telephone is removed. The ability to distribute power to network appliances or circuits enable network appliances such as a VOIP telephone to operate in a fashion similar to ordinary analog telephone networks currently in use.

Distribution of power over Ethernet (PoE) network connections is in part governed by the Institute of Electrical and Electronics Engineers (IEEE) Standard 802.3 and other relevant standards, standards that are incorporated herein by reference. However, power distribution schemes within a network environment typically employ cumbersome, real estate intensive, magnetic transformers. Additionally, power over Ethernet (PoE) specifications under the IEEE 802.3 standard are stringent and often limit allowable power.

Many limitations are associated with use of magnetic transformers. Transformer core saturation can limit current that can be sent to a power device, possibly further limiting communication channel performance. Cost and board space associated with the transformer comprise approximately 10 percent of printed circuit board (PCB) space within a modern switch. Additionally, failures associated with transformers often account for a significant number of field returns. Magnetic fields associated with the transformers can result in lower electromagnetic interference (EMI) performance.

However, magnetic transformers also perform several important functions such as supplying DC isolation and signal transfer in network systems. Thus, an improved approach to distributing power in a network environment may be sought that addresses limitations imposed by magnetic transformers while maintaining transformer benefits.

### SUMMARY

According to an embodiment of a network device, an interface is coupled between an Ethernet physical layer (PHY) module and a network connector, and comprises at least one pair of pins coupled to output connections of the Ethernet physical layer (PHY), a direct current (DC) blocking capacitor coupled to each pin, and a common-mode suppression amplifier coupled between the paired pins.

### BRIEF DESCRIPTION OF THE DRAWINGS

Embodiments of the invention relating to both structure and method of operation may best be understood by referring to the following description and accompanying drawings:

FIGS. 1A and 1B are schematic block diagrams that respectively illustrate a high level example embodiments of client devices in which power is supplied separately to network attached client devices, and a switch that is a power supply equipment (PSE)-capable power-over Ethernet (PoE) enabled LAN switch that supplies both data and power signals to the client devices;

FIG. 2 is a functional block diagram illustrating a network interface including a network powered device (PD) interface and a network power supply equipment (PSE) interface, each implementing a non-magnetic transformer and choke circuitry;

FIG. 3 is a schematic block and circuit diagram showing embodiments of a network device adapted for common-mode noise suppression;

FIGS. 4A and 4B are schematic block and circuit diagrams depicting embodiments of a network system including a common-mode suppression circuit;

FIGS. 5A and 5B are schematic circuit and block diagrams which illustrate example implementations of a transformer function for usage in a power-over-Ethernet application;

FIG. 6 is a schematic circuit diagram showing an embodiment of a T connect integrated circuit that includes a common-mode suppression circuit; and

FIG. 7 is a schematic block and circuit diagram showing an embodiment of a system architecture that integrates common-mode rejection with T connect functionality.

### DETAILED DESCRIPTION

In an illustrative architecture of a common-mode suppression circuit, a common-mode suppression amplifier may be added directly to the output lines of a Ethernet physical layer (PHY).

The common-mode suppression circuit senses common-mode and may use an amplifier, which only operates in a common-mode sense, to suppress noise from a Ethernet physical layer (PHY) or any noise from the remainder of a network system.

In various embodiments, common-mode noise may be sensed directly at the output terminal of the Ethernet physical layer (PHY), may be sensed at the location of a network connector jack, as close as possible to the network line, or may be sensed at any location between the line and the PHY. Typically, sensing of common-mode noise as close as possible to the network line is an optimum sensing point, preventing common-mode noise from passing out on the line and enabling maximum noise suppression.

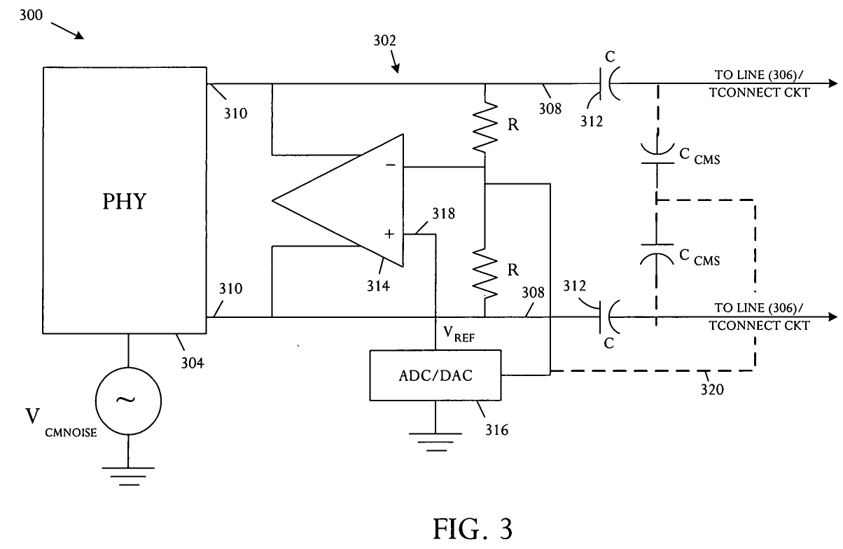

Referring to FIG. 3, a schematic block and circuit diagram illustrates an embodiment of a network device 300 adapted for common-mode noise suppression. The illustrative network device 300 comprises an interface 302 coupled between an Ethernet physical layer (PHY) module 304 and a network connector 306. The interface 302 comprises at least one pair of pins 308 coupled to output connections 310 of the Ethernet physical layer (PHY) 304. A direct current (DC) blocking capacitor 312 is coupled to each pin 308. A common-mode suppression amplifier 314 is coupled between the paired pins 308. In a particular embodiment, the interface 302 may be a 10/1000 Mbps Ethernet or Gigabit Ethernet with four pair of pins 308 of which only a single pair is depicted. In other embodiments, the interface may be configured for usage with any suitable communication technology, such as lower frequency or intermediate frequency (IF) wireless, that uses common-mode noise suppression to handle emissions standards as set by the Federal Communication Commission (FCC) in the United States, International Special Committee on Radio Interference (CISPR) in Europe, and the like.

The illustrative interface 302 includes two additional pins 308 that couple to the output lines of the PHY 304. The two lines 308 are used to sense common-mode noise on the PHY output connections 310. Pins 308 can be added at any suitable location in the interface 302 to enable sensing of common-mode noise at any position the noise may be emitted. The pins 308 and the common-mode suppression amplifier 314 may be independently positioned in a manner that enables efficient processing and reduction or elimination of noise emissions. In other embodiments, the interface 302 may be integrated on the same die as the PHY so that additional pins are not needed. Also some embodiments may incorporate emission reduction circuitry integrated with a transmitter/receiver of the PHY.

The interface 302 to a Ethernet physical layer (PHY) 304 includes the extra pins 308 that enable sensing common-mode noise. The pins 308 facilitate implementation of an active choke.

In some embodiments, the network device 300 may further comprise a control device 316 coupled to the common-mode suppression amplifier 314 and the Ethernet physical layer (PHY) 304. The control device 316, shown in the illustrative embodiment as an analog-to-digital converter and digital-to-analog converter (ADC/DAC) element, controls the common-mode suppression amplifier 314 to enable the Ethernet physical layer (PHY) 304 to set a direct current (DC) value of common-mode voltage and suppress high-frequency common-mode signal components on the paired pins 308.

The interface 302 has the common-mode suppression amplifier 314 coupled to the output connection 310 of the Ethernet physical layer (PHY) 304. The control device 316 generates a clean or low-noise reference voltage for application to the common-mode suppression amplifier 314. The common-mode suppression amplifier 314 may be either DC-coupled or AC-coupled to the Ethernet physical layer (PHY) 304 so long as a low-noise reference signal is applied to control the amplifier 314 for comparison to common-mode noise in the system, facilitating suppression of the common-mode noise. The reference signal may be called a ground referenced signal that may, for example, be referenced to the ground level in the PHY.

The control device 316 may generate a reference voltage Vref created by sampling the common-mode voltage at the output terminal of the Ethernet physical layer (PHY) 304 at a regular, but low frequency, interval and then adjusting a DAC code to be close to the common-mode voltage value. The precise Vref reference is typically unnecessary unless the interface is DC-coupled to the output lines of the PHY. In another embodiment, the control device 316 may be replaced by a very low frequency lowpass filter. A suitable operation enables the Ethernet physical layer (PHY) 304 to set the DC value of the common-mode voltage and suppress the high frequency component.

In a particular implementation, the control device 316 may sample common-mode voltage at the Ethernet physical layer (PHY) output connections 310 at regular intervals and adjust an input signal 318 to the common-mode suppression amplifier 314 to approximate the common-mode voltage.

The common-mode suppression circuit 302 senses common-mode and uses the common-mode suppression amplifier 314 to suppress noise from a Ethernet physical layer (PHY) or any noise from the remainder of a network system. For example, a network device 300 with power-over-Ethernet (POE) functionality may include a DC-DC converter to transition from high power signal levels on the network to low voltage electronic or signal handling electronics at the Ethernet physical layer (PHY) 304. DC-DC converters may generate a relatively large noise signal that is suppressed by the common-mode suppression circuit 302.

In some configurations, the control device 316 may be direct-current (dc)-coupled to the Ethernet physical layer (PHY) 304 and may adjust a control signal 318 to the common-mode suppression amplifier 314 to adjust common-mode of the common-mode amplifier 314 at an amplitude that avoids overdriving. In other arrangements, the control device 316 may be alternating-current (ac)-coupled to the Ethernet physical layer (PHY) 304 and adjust the control signal 318 to the common-mode suppression amplifier 314 to suppress common-mode noise. The control device 316 may be configured to set common-mode direct current (dc) voltage and suppress common-mode noise above a designated frequency.

The illustrative network device 300 includes a common-mode suppression amplifier 314 that is separated from an integrated circuit containing the Ethernet physical layer (PHY) 304.

In some embodiments, the common-mode suppression amplifier 314 may comprise a bandpass filter. For example, in a configuration that the Ethernet physical layer (PHY) 304 uses inductors, AC coupling may be used on the input terminals to the Ethernet physical layer (PHY) 304 and on a fixed input reference, resulting in the common-mode rejection (CMRR) function being operative as a bandpass filter. The common-mode suppression amplifier 314 may have some bandpass functionality that does not suppress the common-mode at low frequencies at the output connection 310 of the Ethernet physical layer (PHY) 304 due to AC coupling and, at very high frequencies, due to the finite bandwidth of the amplifier 314. Accordingly, the common-mode suppression circuit 302 does not directly couple to the Ethernet physical layer (PHY) 304 but rather sets common-mode DC voltage and operates to suppress the common-mode noise above a predetermined frequency.

In other embodiments, the common-mode suppression amplifier 314 may comprise lowpass filter functionality when DC coupled to the output of the PHY, although low-frequency noise added after the DC blocking capacitance cannot be suppressed.

In the illustrative embodiment, the common-mode suppression amplifier 314 is coupled to the paired pins 308 between the DC blocking capacitors 312 and the Ethernet physical layer (PHY) output connections 310.

FIG. 3 illustrates dashed lines 320 depicting AC coupling of the network connector 306 to the common-mode suppression circuit 302. The sense line 320 for sensing common-mode noise is coupled to the opposing side of the DC blocking capacitors 312 with respect to the common-mode suppression amplifier 314 to facilitate sensing the common-mode noise emitted out to the network line. To ensure suppression of noise closest to the network connector 306, the interface 302 is configured to sense on the opposite side of the DC blocking capacitors 312 from the Ethernet physical layer (PHY) 304 thereby suppressing the common-mode noise before the noise can be emitted to the line.

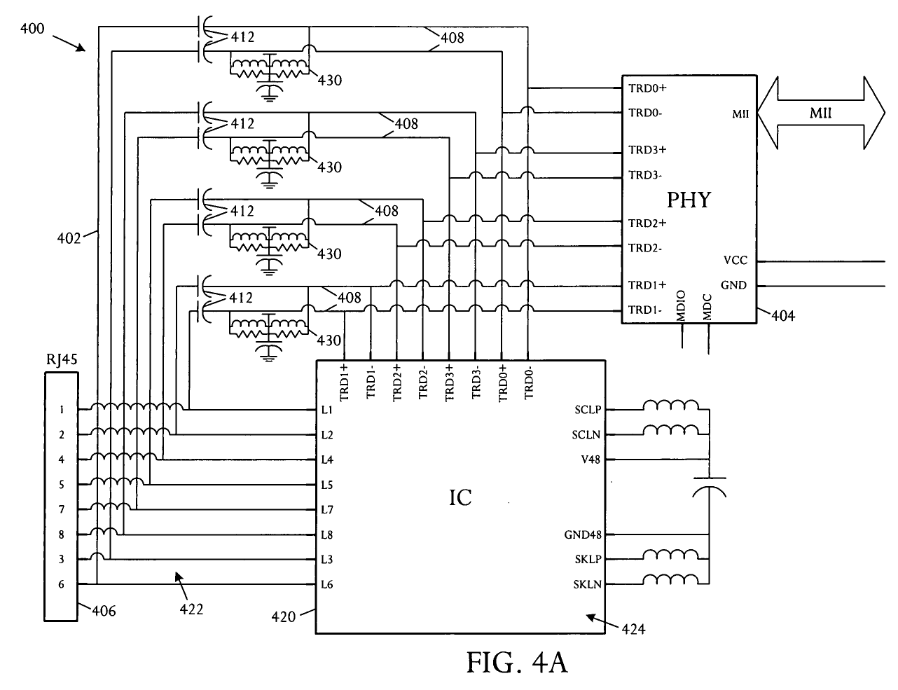

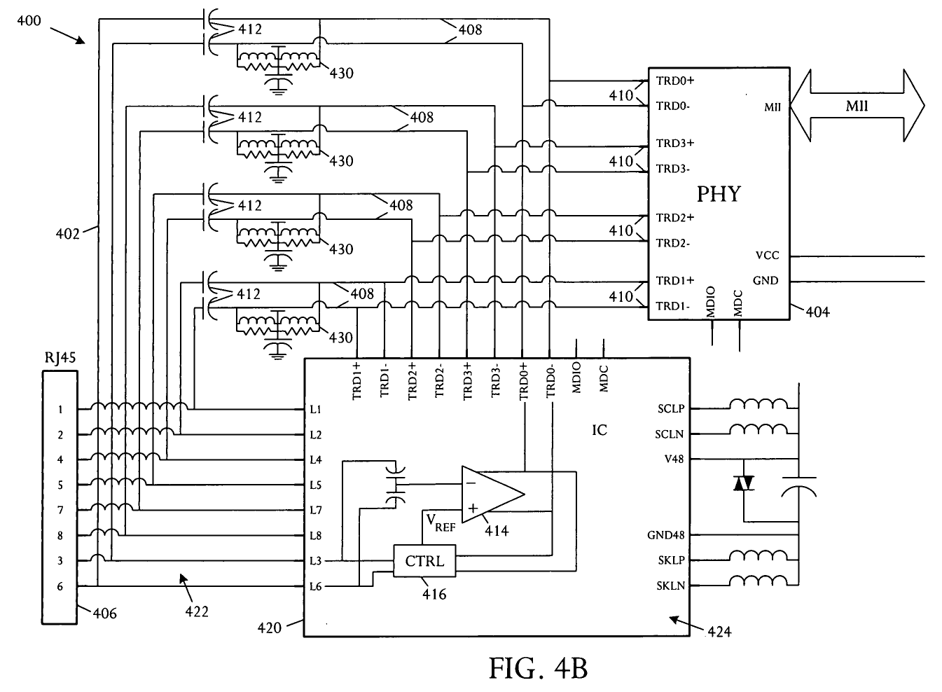

Referring to FIG. 4A, a schematic block and circuit diagram illustrates an embodiment of a network system 400 comprising a network interface 402 coupled between a Ethernet physical layer (PHY) module 404, a network connector 406, and a T connect integrated circuit 420.

The system 400 includes a network device comprising the network interface 402 coupled between the Ethernet physical layer (PHY) module 404 and a network connector 406 that is operative at a voltage substantially higher than the voltage at which the PHY module 404 operates. The interface 402 is configured to pass signals from a relatively high voltage technology at the network connector 406 to a relatively low voltage technology at the PHY module 404. The interface 402 senses common-mode noise in a high voltage technology region 422 adjacent to the network connector 406 suppresses the common-mode noise in a low voltage technology region 424 adjacent to the PHY module 404.

The illustrative network system 400 may further comprise networks 430 coupled between the paired pins 408. Networks 430 may be used to facilitate PHY operation in interfaces that do not contain a transformer and to comply with return loss specifications in the integrated circuit 420.

The network interface 402 is shown AC coupled into the Ethernet physical layer (PHY) 404. A pin interface includes two pins 408 tied to the output of the Ethernet physical layer (PHY) that function to suppress common-mode noise. The pin connections 408 include one set of pins coupled to L lines in the integrated connect circuit 420 that connect to the T connect circuit. The pin connections 408 also include a set of pins coupled to TRD lines in the integrated circuit 420 that couple to a common-mode suppressing circuit. The interface 402 also has an inductor-resistor-capacitor network 430 shown adjacent to the blocking capacitors 412.

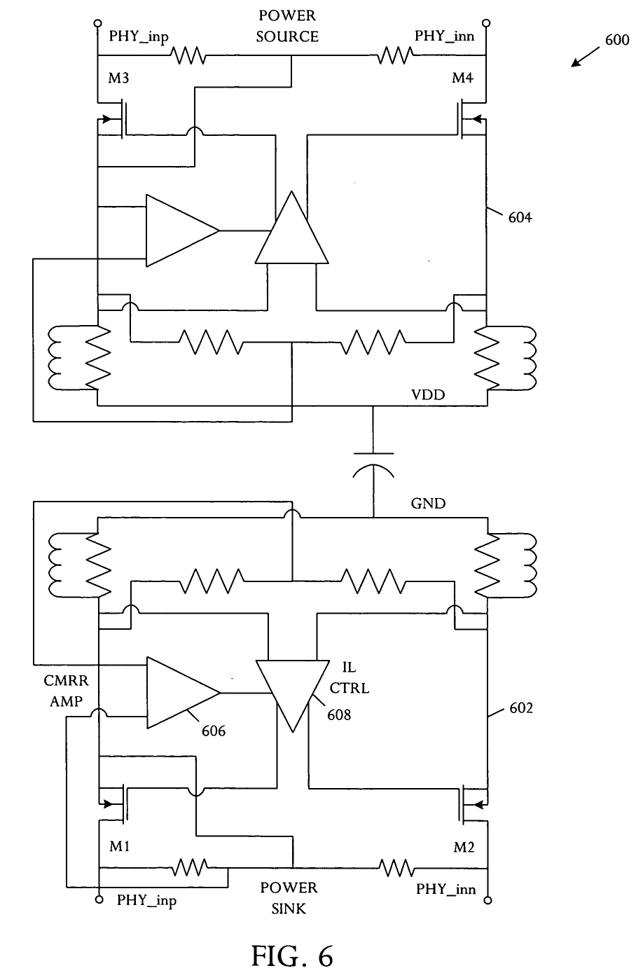

In various implementations, common-mode noise may be sensed either at the pins 408 or on the other side of the direct-current blocking capacitors 412, shown as the L1-L8 pins, to suppress noise at the network line. The L1-L8 pins are T connect input pins, for example that couple to the drains of transistors such as the transistors M1-M4 shown in FIG. 6. Inductors on the SCL/SKL pins are the inductors shown in the sources of the transistors M1-M4. Common-mode noise can be sensed closest to the network line by tapping into the interface 402 on lines that couple the T connect to the network connector 406, for example lines connected to the L1-L8 pins of the integrated circuit 420. Tapping the interface 402 in this manner enables access directly to pins on the network connector 406 such as an RJ45 connector so that common-mode noise is sensed very close to the network line. The common-mode noise is thus sensed at the network line and signals are passed internally to the integrated circuit 420 to a common-mode suppression amplifier in the integrated circuit 420 which suppresses the common-mode noise at the TRD pins. The configuration enables the interface 402 to be implemented with different technologies including a low voltage technology internal to the integrated circuit 420 and a high voltage technology on a separate die. For example, different technologies may be used because the capacitors function as a coupling network and block high DC voltage so that the capacitors would suitably be implemented in a high voltage die. Signals are sensed at the high voltage region and passed from the high voltage technology on the L1-L8 lines down to a low voltage technology at the TRD lines of the integrated circuit 420. Output signals from the Ethernet physical layer (PHY) 404 enable usage of low voltage technology and increased bandwidth to perform common-mode suppression. The T connect integrated circuit 420 may include a DC-DC converter which has noise that passes through the T connect and exits the line 406. The common-mode sense circuit 402 can better suppress the noise if the common-mode noise is sensed on the line side of the DC blocking capacitors 412.

FIG. 4B is a schematic block and circuit diagram illustrating a further embodiment of a network system 400. In an illustrative implementation, the low voltage technology region 424 comprises an integrated circuit 420 configured in fine-line geometries. A common-mode suppression amplifier 414 may be fabricated in the low voltage technology region 424 and adapted to suppress the common-mode noise. The low voltage region 424 enables power efficient operation including usage of low-voltage devices. Separation of the common-mode sensing from common-mode suppression further enables division of the interface 402 into low voltage and high voltage regions.

The interface 402 may comprise at least one pair of pins 408 coupled to output connections 410 of the Ethernet physical layer (PHY) 404 and a common-mode suppression amplifier 414 coupled between the paired pins 408.

A control device 416 coupled to the common-mode suppression amplifier 414 and the Ethernet physical layer (PHY) 404 may be adapted to control the common-mode suppression amplifier 414, enabling the Ethernet physical layer (PHY) 404 to set a direct current (DC) value of common-mode voltage and suppress high-frequency common-mode signal components on the paired pins 408. The control device 416 may be adapted to sample common-mode voltage at the Ethernet physical layer (PHY) output connections at regular intervals and adjust input to the common-mode suppression amplifier to approximate the common-mode voltage. Capacitors 418 coupled to the input line to the common-mode suppression amplifier 414 may be implemented on a high voltage semiconductor die to facilitate blockage of high DC voltage.

The IEEE 802.3 Ethernet Standard, which is incorporated herein by reference, addresses loop powering of remote Ethernet devices (802.3af). Power over Ethernet (PoE) standard and other similar standards support standardization of power delivery over Ethernet network cables to power remote client devices through the network connection. The side of link that supplies power is called Powered Supply Equipment (PSE). The side of link that receives power is the Powered device (PD). Other implementations may supply power to network attached devices over alternative networks such as, for example, Home Phoneline Networking alliance (HomePNA) local area networks and other similar networks. HomePNA uses existing telephone wires to share a single network connection within a home or building. In other examples, devices may support communication of network data signals over power lines.

In various configurations described herein, a magnetic transformer of conventional systems may be eliminated while transformer functionality is maintained. Techniques enabling replacement of the transformer may be implemented in the form of integrated circuits (ICs) or discrete components.

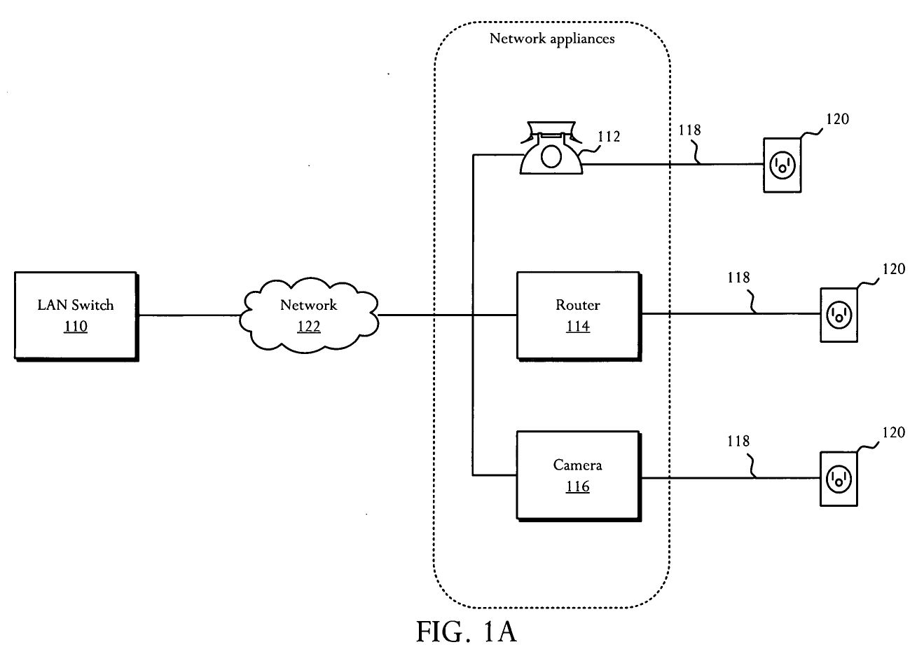

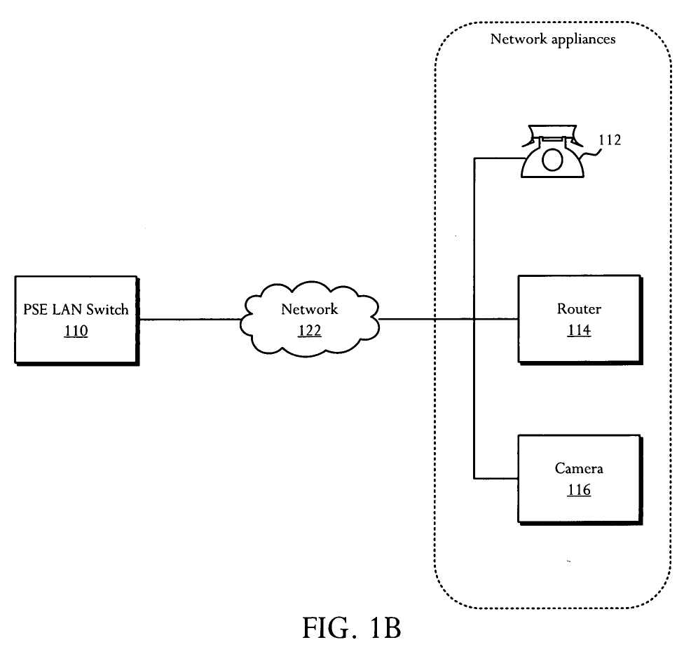

FIG. 1A is a schematic block diagram that illustrates a high level example embodiment of devices in which power is supplied separately to network attached client devices 112 through 116 that may benefit from receiving power and data via the network connection. The devices are serviced by a local area network (LAN) switch 110 for data. Individual client devices 112 through 116 have separate power connections 118 to electrical outlets 120. FIG. 1B is a schematic block diagram that depicts a high level example embodiment of devices wherein a switch 110 is a power supply equipment (PSE)-capable power-over Ethernet (PoE) enabled LAN switch that supplies both data and power signals to client devices 112 through 116. Network attached devices may include a Voice Over Internet Protocol (VOIP) telephone 112, access points, routers, gateways 114 and/or security cameras 116, as well as other known network appliances. Network supplied power enables client devices 112 through 116 to eliminate power connections 118 to electrical outlets 120 as shown in FIG. 1A. Eliminating the second connection enables the network attached device to have greater reliability when attached to the network with reduced cost and facilitated deployment.

Although the description herein may focus and describe a system and method for coupling high bandwidth data signals and power distribution between the integrated circuit and cable that uses transformer-less ICs with particular detail to the IEEE 802.3af Ethernet standard, the concepts may be applied in non-Ethernet applications and non-IEEE 802.3af applications. Also, the concepts may be applied in subsequent standards that supersede or complement the IEEE 802.3af standard.

Various embodiments of the depicted system may support solid state, and thus non-magnetic, transformer circuits operable to couple high bandwidth data signals and power signals with new mixed-signal IC technology, enabling elimination of cumbersome, real-estate intensive magnetic-based transformers.

Typical conventional communication systems use transformers to perform common mode signal blocking, 1500 volt isolation, and AC coupling of a differential signature as well as residual lightning or electromagnetic shock protection. The functions are replaced by a solid state or other similar circuits in accordance with embodiments of circuits and systems described herein whereby the circuit may couple directly to the line and provide high differential impedance and low common mode impedance. High differential impedance enables separation of the physical layer (PHY) signal from the power signal. Low common mode impedance enables elimination of a choke, allowing power to be tapped from the line. The local ground plane may float to eliminate a requirement for 1500 volt isolation. Additionally, through a combination of circuit techniques and lightning protection circuitry, voltage spike or lightning protection can be supplied to the network attached device, eliminating another function performed by transformers in traditional systems or arrangements. The disclosed technology may be applied anywhere transformers are used and is not limited to Ethernet applications.

Specific embodiments of the circuits and systems disclosed herein may be applied to various powered network attached devices or Ethernet network appliances. Such appliances include, but are not limited to VoIP telephones, routers, printers, and other similar devices.

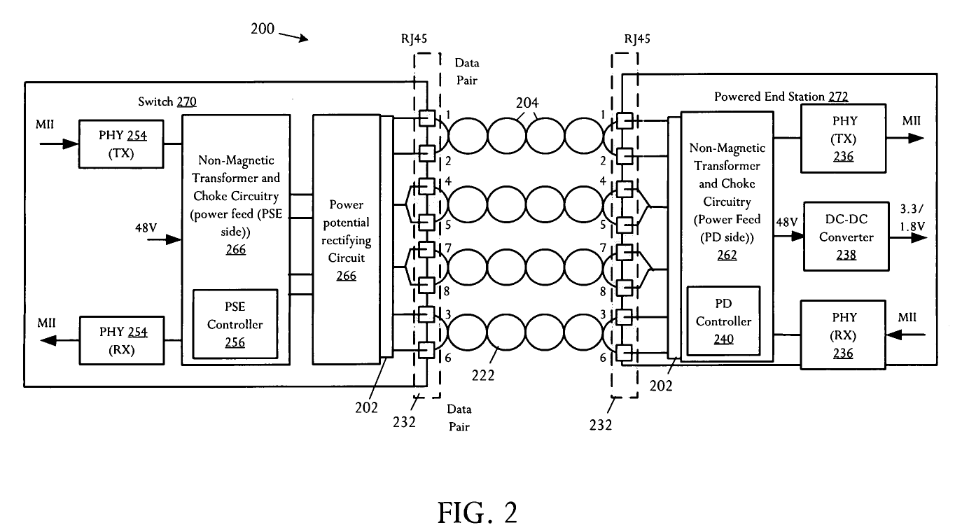

Referring to FIG. 2, a functional block diagram depicts an embodiment of a network device 200 including to power potential rectification. The illustrative network device comprises a power potential rectifier 202 adapted to conductively couple a network connector 232 to an integrated circuit 270, 272 that rectifies and passes a power signal and data signal received from the network connector 232. The power potential rectifier 202 regulates a received power and/or data signal to ensure proper signal polarity is applied to the integrated circuit 270, 272.

The network device 200 is shown with the power sourcing switch 270 sourcing power through lines 1 and 2 of the network connector 232 in combination with lines 3 and 6.

In some embodiments, the power potential rectifier 202 is configured to couple directly to lines of the network connector 232 and regulate the power signal whereby the power potential rectifier 202 passes the data signal with substantially no degradation.

In some configuration embodiments, the network connector 232 receives multiple twisted pair conductors 204, for example twisted 22-26 gauge wire. Any one of a subset of the twisted pair conductors 204 can forward bias to deliver current and the power potential rectifier 202 can forward bias a return current path via a remaining conductor of the subset.

FIG. 2 illustrates the network interface 200 including a network powered device (PD) interface and a network power supply equipment (PSE) interface, each implementing a non-magnetic transformer and choke circuitry. A powered end station 272 is a network interface that includes a network connector 232, non-magnetic transformer and choke power feed circuitry 262, a network physical layer 236, and a power converter 238. Functionality of a magnetic transformer is replaced by circuitry 262. In the context of an Ethernet network interface, network connector 232 may be a RJ45 connector that is operable to receive multiple twisted wire pairs. Protection and conditioning circuitry may be located between network connector 232 and non-magnetic transformer and choke power feed circuitry 262 to attain surge protection in the form of voltage spike protection, lighting protection, external shock protection or other similar active functions. Conditioning circuitry may be a diode bridge or other rectifying component or device. A bridge or rectifier may couple to individual conductive lines 1-8 contained within the RJ45 connector. The circuits may be discrete components or an integrated circuit within non-magnetic transformer and choke power feed circuitry 262.

In an Ethernet application, the IEEE 802.3af standard (PoE standard) enables delivery of power over Ethernet cables to remotely power devices. The portion of the connection that receives the power may be referred to as the powered device (PD). The side of the link that supplies power is called the power sourcing equipment (PSE).

In the powered end station 272, conductors 1 through 8 of the network connector 232 couple to non-magnetic transformer and choke power feed circuitry 262. Non-magnetic transformer and choke power feed circuitry 262 may use the power feed circuit and separate the data signal portion from the power signal portion. The data signal portion may then be passed to the network physical layer (PHY) 236 while the power signal passes to power converter 238.

If the powered end station 272 is used to couple the network attached device or PD to an Ethernet network, network physical layer 236 may be operable to implement the 10 Mbps, 100 Mbps, and/or 1 Gbps physical layer functions as well as other Ethernet data protocols that may arise. The Ethernet PHY 236 may additionally couple to an Ethernet media access controller (MAC). The Ethernet PHY 236 and Ethernet MAC when coupled are operable to implement the hardware layers of an Ethernet protocol stack. The architecture may also be applied to other networks. If a power signal is not received but a traditional, non-power Ethernet signal is received the nonmagnetic power feed circuitry 262 still passes the data signal to the network PHY.

The power signal separated from the network signal within non-magnetic transformer and choke power feed circuit 262 by the power feed circuit is supplied to power converter 238. Typically the power signal received does not exceed 57 volts SELV (Safety Extra Low Voltage). Typical voltage in an Ethernet application is 48-volt power. Power converter 238 may then further transform the power as a DC to DC converter to provide 1.8 to 3.3 volts, or other voltages specified by many Ethernet network attached devices.

Power-sourcing switch 270 includes a network connector 232, Ethernet or network physical layer 254, PSE controller 256, non-magnetic transformer and choke power supply circuitry 266, and possibly a multiple-port switch. Transformer functionality is supplied by non-magnetic transformer and choke power supply circuitry 266. Power-sourcing switch 270 may be used to supply power to network attached devices. Powered end station 272 and power sourcing switch 270 may be applied to an Ethernet application or other network-based applications such as, but not limited to, a vehicle-based network such as those found in an automobile, aircraft, mass transit system, or other like vehicle. Examples of specific vehicle-based networks may include a local interconnect network (LIN), a controller area network (CAN), or a flex ray network. All may be applied specifically to automotive networks for the distribution of power and data within the automobile to various monitoring circuits or for the distribution and powering of entertainment devices, such as entertainment systems, video and audio entertainment systems often found in today's vehicles. Other networks may include a high speed data network, low speed data network, time-triggered communication on CAN (TTCAN) network, a J1939-compliant network, ISO I1898-compliant network, an ISO11519-2-compliant network, as well as other similar networks. Other embodiments may supply power to network attached devices over alternative networks such as but not limited to a HomePNA local area network and other similar networks. HomePNA uses existing telephone wires to share a single network connection within a home or building. Alternatively, embodiments may be applied where network data signals are provided over power lines.

Non-magnetic transformer and choke power feed circuitry 262 and 266 enable elimination of magnetic transformers with integrated system solutions that enable an increase in system density by replacing magnetic transformers with solid state power feed circuitry in the form of an integrated circuit or discreet component.

In some embodiments, non-magnetic transformer and choke power feed circuitry 262, network physical layer 236, power distribution management circuitry 254, and power converter 238 may be integrated into a single integrated circuit rather than discrete components at the printed circuit board level. Optional protection and power conditioning circuitry may be used to interface the integrated circuit to the network connector 232.

The Ethernet PHY may support the 10/100/1000 Mbps data rate and other future data networks such as a 10000 Mbps Ethernet network. Non-magnetic transformer and choke power feed circuitry 262 supplies line power minus the insertion loss directly to power converter 238, converting power first to a 12V supply then subsequently to lower supply levels. The circuit may be implemented in any appropriate process, for example a 0.18 or 0.13 micron process or any suitable size process.

Non-magnetic transformer and choke power feed circuitry 262 may implement functions including IEEE 802.3.af signaling and load compliance, local unregulated supply generation with surge current protection, and signal transfer between the line and integrated Ethernet PHY. Since devices are directly connected to the line, the circuit may be implemented to withstand a secondary lightning surge.

For the power over Ethernet (PoE) to be IEEE 802.3af standard compliant, the PoE may be configured to accept power with various power feeding schemes and handle power polarity reversal. A rectifier, such as a diode bridge, a switching network, or other circuit, may be implemented to ensure power signals having an appropriate polarity are delivered to nodes of the power feed circuit. Any one of the conductors 1, 4, 7 or 3 of the network RJ45 connection can forward bias to deliver current and any one of the return diodes connected can forward bias to form a return current path via one of the remaining conductors. Conductors 2, 5, 8 and 4 are connected similarly.

Non-magnetic transformer and choke power feed circuitry 262 applied to PSE may take the form of a single or multiple port switch to supply power to single or multiple devices attached to the network. Power sourcing switch 270 may be operable to receive power and data signals and combine to communicate power signals which are then distributed via an attached network. If power sourcing switch 270 is a gateway or router, a high-speed uplink couples to a network such as an Ethernet network or other network. The data signal is relayed via network PHY 254 and supplied to non-magnetic transformer and choke power feed circuitry 266. PSE switch 270 may be attached to an AC power supply or other internal or external power supply to supply a power signal to be distributed to network-attached devices that couple to power sourcing switch 270. Power controller 256 within or coupled to non-magnetic transformer and choke power feed circuitry 266 may determine, in accordance with IEEE standard 802.3af, whether a network-attached device in the case of an Ethernet network-attached device is a device operable to receive power from power supply equipment. When determined that an IEEE 802.3af compliant powered device (PD) is attached to the network, power controller 256 may supply power from power supply to non-magnetic transformer and choke power feed circuitry 266, which is sent to the downstream network-attached device through network connectors, which in the case of the Ethernet network may be an RJ45 receptacle and cable.

IEEE 802.3af Standard is to fully comply with existing non-line powered Ethernet network systems. Accordingly, PSE detects via a well-defined procedure whether the far end is PoE compliant and classify sufficient power prior to applying power to the system. Maximum allowed voltage is 57 volts for compliance with SELV (Safety Extra Low Voltage) limits.

For backward compatibility with non-powered systems, applied DC voltage begins at a very low voltage and only begins to deliver power after confirmation that a PoE device is present. In the classification phase, the PSE applies a voltage between 14.5V and 20.5V, measures the current and determines the power class of the device. In one embodiment the current signature is applied for voltages above 12.5V and below 23 Volts. Current signature range is 0-44 mA.

The normal powering mode is switched on when the PSE voltage crosses 42 Volts where power MOSFETs are enabled and the large bypass capacitor begins to charge.

A maintain power signature is applied in the PoE signature block—a minimum of 10 mA and a maximum of 23.5 kohms may be applied for the PSE to continue to feed power. The maximum current allowed is limited by the power class of the device (class 0-3 are defined). For class 0, 12.95 W is the maximum power dissipation allowed and 400 ma is the maximum peak current. Once activated, the PoE will shut down if the applied voltage falls below 30V and disconnect the power MOSFETs from the line.

Power feed devices in normal power mode provide a differential open circuit at the Ethernet signal frequencies and a differential short at lower frequencies. The common mode circuit presents the capacitive and power management load at frequencies determined by the gate control circuit.

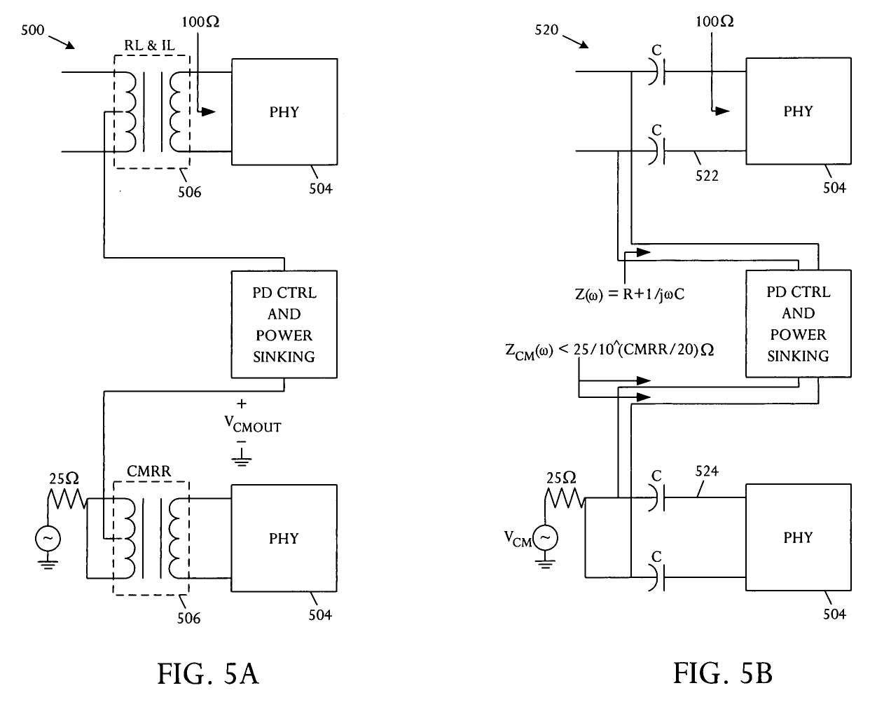

Referring to FIGS. 5A and 5B, two schematic circuit and block diagrams illustrate example implementations of a transformer function for usage in a power-over-Ethernet application. FIG. 5A shows a transformer-based design 500 whereby power is supplied to an Ethernet physical layer (PHY) 504 through a transformer 506 and the transformer 506 has an integrated choke that suppresses common-mode noise from the PHY 504. The integrated choke functions in combination with the transformer 506 to suppress common-mode noise that creates noise emission.

FIG. 5B shows a direct connect design 520 whereby power is supplied to the Ethernet physical layer (PHY) 504 through the direct connect circuit. A T connect circuit 522 may be implemented to suppress the common-mode noise. The illustrative implementation of the direct connect design 520 has a choke function 524 integrated with the T connect 522. The T connect element 522 separates a power potential from an Ethernet signal. The choke function 524 may be integrated into a circuit in combination with the T connect element 522 so that the T connect performs at least power separation and common-mode noise suppression as elements of a global function. Goals of the choke function include high noise rejection and an equivalent common-mode impedance in a range of less than about an ohm at 100 MHz that typically can be attained only by a very high-gain amplifier. In an illustrative implementation, performance of the transformer/choke for common-mode noise rejection (CMRR) is approximately 43 dB for CMRR (1 MHz-30 MHz) and about 43−20×log₁₀ (f/30)dB for CMRR (30 MHz-100 MHz). Equivalent common-mode resistance for CMRR (1 MHz-30 MHz) is about 0.2Ω. Equivalent common-mode resistance for CMRR (30 MHz-100 MHz) is about 0.6Ω at 100 MHz.

One difficulty with the global integrated circuit architecture arises from a wide difference in voltage at which the different functions optimally operate. Power is supplied over the network so that high voltage signals are supplied at the network connector. The interface separates and supplies the high power supply voltages to the PHY element which, in turn, is desired to operate on low voltage, high-speed technology which is much more power efficient than high-voltage technology and generates much less noise. Accordingly, the implementations depicted in FIGS. 3, 4A, and 4B have the common-mode noise suppression operation separated from the T connection functionality including pins added at any suitable location in the interface to enable sensing of common-mode noise at any position the noise may be emitted. Independent positioning of the pins and the common-mode suppression amplifier facilitates efficient processing and reduction or elimination of noise emissions. The pins may be located in high-voltage regions for sensing of noise emissions and the amplifier may be positioned in low-voltage, high-speed regions to enable the amplifier to operate at high speeds and thereby improve common-mode noise suppression.

The transformer depicted in FIG. 5A performs various functions in addition to separation of power and Ethernet signals such as filtering. The implementations depicted in FIGS. 3, 4A, and 4B are adapted to perform similar functionality, for example through inclusion of various filters including the common-mode suppression filtering.

Referring to FIG. 6, a schematic circuit diagram illustrates an embodiment of a T connect integrated circuit 600 that includes a common-mode suppression circuit 602 in combination with a T connect circuit 604 that separates power from Ethernet signals in a power-over-Ethernet (POE) application. In the implementation, inductive/resistive degeneration increases differential resistance. The T connect integrated circuit 600 includes an additional common-mode amplifier 606 for suppressing common-mode noise. The common-mode suppression circuit 602 includes an amplifier 606 for common-mode resistance reduction and an amplifier 608 for insertion loss control. The illustrative integrated circuit 600 meets differential resistance specifications easily with minimum insertion loss and conveniently attains desired functionality within a single integrated circuit. A high differential resistance specification competes against a specification for low common-mode resistance. The implementation also has difficulty in attaining sufficient common-mode loop bandwidth.

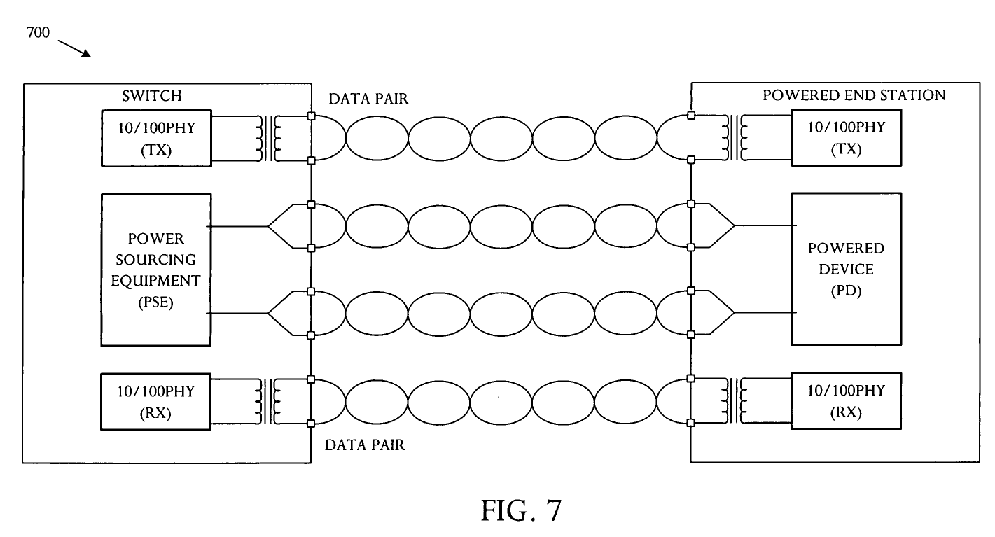

Referring to FIG. 7, a schematic block and circuit diagram depicts an embodiment of a system architecture 700 for the purpose of describing a further difficulty with integrating common-mode rejection with T connect functionality. In the illustrative configuration, for example called a Type B configuration, power is delivered separately from the Ethernet physical layer (PHY) signal so that integrating common-mode rejection into the circuit does not suppress noise from the PHY. In contrast, in a common or Type A configuration power is delivered on the same lines as the PHY signal. Accordingly, since alternative connection schemes may be used, one which supplies power on the same lines as the Ethernet signal and one delivering power on different lines from the Ethernet signal, an integrated circuit that combines T connect and common-mode suppression would be unable to address both alternatives, possibly calling for design of a second circuit. In a power-over-Ethernet (POE) system which uses a single T connect integrated circuit for alternative A and B configurations, a condition may result for the B configuration that power can be delivered on non-signal lines. Power is not delivered on the Ethernet signal lines so that the integrated circuit suppresses common-mode noise on a line that does not carry the Ethernet signal.

Separating the common-mode rejection functionality from the T connect functionality as shown in FIGS. 3, 4A, and 4B enables a much simpler design configuration and enables a single design to be used for both Alternative A and Alternative B implementations. The separated implementation avoids requirement for a high efficiency boosting power supply and may be less sensitive to parasitics for the common-mode rejection (CMRR) amplifier, although the implementation way have a higher power consumption in the Approach A configuration.

Terms “substantially”, “essentially”, or “approximately”, that may be used herein, relate to an industry-accepted tolerance to the corresponding term. Such an industry-accepted tolerance ranges from less than one percent to twenty percent and corresponds to, but is not limited to, component values, integrated circuit process variations, temperature variations, rise and fall times, and/or thermal noise. The term “coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. Inferred coupling, for example where one element is coupled to another element by inference, includes direct and indirect coupling between two elements in the same manner as “coupled”.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims. For example, various aspects or portions of a network interface are described including several optional implementations for particular portions. Any suitable combination or permutation of the disclosed designs may be implemented.

What is claimed is:

1. A network device comprising:
an interface coupled between an Ethernet physical layer (PHY) module and a network connector, the interface comprising at least one pair of pins coupled to output connections of the Ethernet physical layer (PHY), a direct current (DC) blocking capacitor coupled to each pin, and a common-mode suppression amplifier coupled between the paired pins.

2. The network device according to claim 1 further comprising:
the common-mode suppression amplifier coupled to the paired pins between the DC blocking capacitors and the Ethernet physical layer (PHY) output connections.

3. The network device according to claim 1 further comprising:
the DC blocking capacitors coupled to the paired pins between the Ethernet physical layer (PHY) output connections and the common-mode suppression amplifier.

4. The network device according to claim 1 further comprising:
a control device coupled to the common-mode suppression amplifier and the Ethernet physical layer (PHY) that controls the common-mode suppression amplifier to enable the Ethernet physical layer (PHY) to set a direct current (DC) value of common-mode voltage and suppress high-frequency common-mode signal components on the paired pins.

5. The network device according to claim 1 further comprising:
a control device coupled to the common-mode suppression amplifier and the Ethernet physical layer (PHY) that samples common-mode voltage at the Ethernet physical layer (PHY) output connections at regular intervals and adjusts input to the common-mode suppression amplifier to approximate the common-mode voltage.

6. The network device according to claim 1 further comprising:
a control device direct-current (dc)-coupled to the Ethernet physical layer (PHY) that adjusts a control signal to the common-mode suppression amplifier and is adapted to adjust common-mode of the common-mode amplifier at an amplitude that avoids overdriving.

7. The network device according to claim 1 further comprising:
a control device alternating-current (ac)-coupled to the Ethernet physical layer (PHY) that adjusts a control signal to the common-mode suppression amplifier and is adapted to suppress common-mode noise.

8. The network device according to claim 1 further comprising:
a control device coupled to the Ethernet physical layer (PHY) that sets a common-mode direct current (dc) voltage and suppresses common-mode noise above a designated frequency.

9. The network device according to claim 1 further comprising:
the common-mode suppression amplifier is separated from an integrated circuit containing the Ethernet physical layer (PHY).

10. The network device according to claim 1 further comprising:
the interface coupled between the Ethernet physical layer (PHY) module, the network connector, and a T connect integrated circuit.

11. The network device according to claim 1 further comprising:
the common-mode suppression amplifier comprising a bandpass filter.

12. The network device according to claim 1 further comprising:
the common-mode suppression amplifier comprising a lowpass filter.

13. The network device according to claim 1 further comprising:
the paired pins coupled to the interface in a configuration adapted to sense common-mode noise at input terminals to the network connector.

14. A network device comprising:
an interface coupled between an Ethernet physical layer (PHY) module and a network connector operative at a voltage substantially higher than the PHY module, the interface configured to pass signals from a relatively high voltage technology at the network connector to a relatively low voltage technology at the PHY module, the interface adapted to sense common-mode noise in a high voltage technology region adjacent to the network connector and adapted to suppress the common-mode noise in a low voltage technology region adjacent to the PHY module.

15. A network device comprising:
an interface coupled between an Ethernet physical layer (PHY) module and a network connector operative at a voltage substantially higher than the PHY module, the interface configured to pass signals from a relatively high voltage technology at the network connector to a relatively low voltage technology at the PHY module, the interface adapted to sense common-mode noise in a high voltage technology region adjacent to the network connector, the high voltage technology region comprising a common-mode suppression amplifier adapted to suppress the common-mode noise in a low voltage technology region adjacent to the PHY module whereby signals are passed to the common-mode suppression amplifier through a capacitor fabricated on a high-voltage die.

16. The network device according to claim 15 further comprising:
the low voltage technology region comprising an integrated circuit configured in fine-line geometries.

17. The network device according to claim 15 further comprising:
a common-mode suppression amplifier fabricated in the low voltage technology region and adapted to suppress the common-mode noise.

18. The network device according to claim 15 further comprising:
the interface comprising at least one pair of pins coupled to output connections of the Ethernet physical layer (PHY) and a common-mode suppression amplifier coupled between the paired pins.

19. The network device according to claim 18 further comprising:
a control device coupled to the common-mode suppression amplifier and the Ethernet physical layer (PHY) that controls the common-mode suppression amplifier to enable the Ethernet physical layer (PHY) to set a direct current (DC) value of common-mode voltage and suppress high-frequency common-mode signal components on the paired pins.

20. The network device according to claim 18 further comprising:
a control device coupled to the common-mode suppression amplifier and the Ethernet physical layer (PHY) that samples common-mode voltage at the Ethernet physical layer (PHY) output connections at regular intervals and adjusts input to the common-mode suppression amplifier to approximate the common-mode voltage.

21. A method of operating a network device comprising:
passing signals from a relatively high voltage technology at a network connector to a relatively low voltage technology at an Ethernet physical layer (PHY) module;
sensing common-mode noise in a high voltage technology region adjacent to the network connector; and
suppressing the common-mode noise in a low voltage technology region adjacent to the PHY module.

22. The method according to claim 21 further comprising:
fabricating a common-mode suppression amplifier in the low voltage technology region; and
suppressing the common-mode noise using the common-mode suppression amplifier.

23. The method according to claim 21 further comprising:
controlling common-mode suppression to enable the Ethernet physical layer (PHY) to set a direct current (DC) value of common-mode voltage and suppress high-frequency common-mode signal components.

24. The method according to claim 21 further comprising:
sampling common-mode voltage at regular intervals; and
adjusting common-mode suppression to approximate the common-mode voltage.

25. The method according to claim 21 further comprising:
setting common-mode direct current (dc) voltage; and
suppressing common-mode noise above a designated frequency.

26. The method according to claim 21 further comprising:
sensing common-mode noise at input terminals to the network connector.

27. A network device comprising:
a network connector adapted to physically couple the network device to a network and receive both a power signal and a data signal through the coupled network;
an integrated circuit coupled to the network connector and comprising at least one functional element, the at least one functional element comprising an Ethernet physical layer (PHY) module; and
an interface coupled between the integrated circuit and the network connector and configured to pass signals from a relatively high voltage technology at the network connector to a relatively low voltage technology at the integrated circuit, the interface adapted to sense common-mode noise at the network connector and adapted to suppress the common-mode noise in the integrated circuit.

28. The network device according to claim 27 further comprising:
the interface comprising at least one pair of pins coupled to output connections of the Ethernet physical layer (PHY), a direct current (DC) blocking capacitor coupled to each pin, and a common-mode suppression amplifier coupled between the paired pins.

29. The network device according to claim 28 further comprising:
a control device coupled to the common-mode suppression amplifier and the Ethernet physical layer (PHY) that controls the common-mode suppression amplifier to enable the Ethernet physical layer (PHY) to set a direct current (DC) value of common-mode voltage and suppress high-frequency common-mode signal components on the paired pins.
